(19) United States
(12) Patent Application Publication
(10) Pub. No.: US 2019/0099306 A1
(43) Pub. Date: Apr. 4, 2019

(54) PLATFORM LIFT FOR ACCESSIBILITY FOR PEOPLE IN A WHEELCHAIR FIVE AXIS MACHINE TOOL

(71) Applicant: Raoul Parienti, Nice (FR)

(72) Inventor: Raoul PARIENTI, Nice (FR)

(21) Appl. No.: 16/085,355

(22) PCT Filed: Mar. 16, 2017
(86) PCT No.: PCT/FR2017/000049

§ 371 Date: Sep. 14, 2018

(30) Foreign Application Priority Data
Mar. 16, 2016 (FR) 16/00434

(51) Int. Cl. A61G 3/06

(52) U.S. Cl. CPC A61G 3/063

(57) ABSTRACT

The invention relates to a platform lift for accessibility for people in a wheelchair, said lift comprising a device for lifting the platform, comprising two cross-members (1) acting as a guiding rail and secured to the staircase; including two carriages (2) to which a platform (3) is secured, the lifting of the platform (3) being carried out by two electric motors provided with a mechanical reducer (4) and secured to the outside of the two cross-members (1); the shafts of the motors being provided with a truncated pinion (5) on each end, driving another truncated pinion united with an endless screw (6).

### TECHNICAL FIELD OF THE INVENTION

The invention described in this document concerns accessibility for people in a wheelchair.

### STATE OF THE ART

The problem touching accessibility for persons suffering from a handicap tied to mobility is a sensitive topic upon which those in government have reflected deeply about in order to find technical solutions which would allow for an alleviation of the handicap linked to mobility by means of adapted means of accessibility.

However, as of today, to be able to overcome those few steps to gain access to businesses and buildings is substantially achieved by access ramps that are at times difficult to implement by heavy and costly technical means.

US patent 2008/0093176 A1 describes a lift platform for persons in wheelchairs. The system does not describe the means of lifting of the platform via 2 electric motors that is provided with a mechanical reducer (4) that operates an endless screw according to the devices described in this document. The technical advantage of these features is a higher torque of the actuator, thereby resolving the problem of the speediness and smoothness of the lifting of the platform.

### SUBJECT MATTER OF THE INVENTION

The invention presented in this document allows for these drawbacks to be overcome.

It concerns a device comprising a platform lift, upon which a person in a wheelchair will place their wheelchair on a platform, a mechanical device will allow the lifting of said wheelchair from the ground to a height in which it will allow the wheelchair to overcome a number of treads, Illustration Plate 1.

The device comprises 2 cross-members (1) acting as guiding rails, separated by approximately 90 cm, secured to the staircase. Said cross-members acting as a rail incorporate 2 carriages (2) to which a platform (3) is secured. The invention comprises means of motorization such as 2 electric motors (4) and mechanical means allowing movement of the platform (3). According to a preferred embodiment of the invention, the movement of the platform is carried by 2 electric motors (4) secured on the outside of the 2 cross-members (1) in order to not impinge upon the available passageway of the staircase. Said motors are necessarily provided with a mechanical reducer in order to obtain an adapted rotation speed. The shafts of the motors are provided on each end with a drive device. such as a truncated cone pinion (5) driving another truncated pinion which is united with an endless screw (6). The endless screw is fitted on at least 2 bearings (7). (only one is represented). The carriage (2) is equipped with:
a screw (8) secured to the carriage and cooperating with the endless screw in such a manner that the rotation of the endless screw (6) drives the linear movement of the carriage.
wheels (9) in contact with the cross-member allowing an ad hoc guidance during the movement of the carriage on the inside of the cross-member.
a means of securing (10) of the platform (3).

The carriage (2) is provided, in part, with a groove (11) allowing the passage of the shaft of the motor (4).

The motor (4) is designed to rotate in one direction or the other to respectively allow for the rise or the descent of the platform.

According to another means of movement of the platform, the same is pulled by an appropriately sized steel cable (16), which winds up around a spool (17) positioned on the shaft of the motor. In this design, the cable pulled by the motor lifts the tie rod, bringing about the lifting of the security plate (18). Illustration Plate 6.

In order to avoid a cantilever problem that multiplies the mechanical constraints, the device comprises 2 tie rods (12), secured to the screw (8) and on the other side to the end of the platform. These tie rods (12) are articulated (13) in such a way that when at rest, they recess into a groove (14) that is hollowed out into the length of the platform. To ensure a proper operation during a movement of the platform, it is necessary, initially, that the tie rods are under tension (lifted). In order to accomplish this, the screw (8) is not initially in contact with the stop of the carriage (18) and an ad hoc functional space (19) is foreseen, allowing the screw to move into this space (19) to place the tie rod under tension, before the screw touches down on the stop (18) and drives the platform.

The 2 motors are synchronized in their rotation by appropriate electronics.

According to an equivalent version of the invention, which is however more elaborate; the device for the driving of the endless screw (6) by the motor (4) is a toothed belt (22). Said belt is driven by a toothed pulley (23) positioned at the end of the motor (4), driving another toothed pulley that is united with the endless screw (24). This type of transmission offers better smoothness while maintaining a significant torque.

Let us highlight that the platform (3) is not overly thick; approximately 10 mm, in order to not impede the passageway of pedestrians. To allow for a suitable mechanical resistance with a reduced thickness, said platform is structured. Moreover, the edges of the platform are chamfered and made highly visible thanks to bright colors in order to avoid that pedestrians might trip. A supplementation of LED (light-emitting diodes) positioned and lighting up during the lifting of the platform will allow the safeguarding of the use. In some cases, said platform can be recessed depending on regulations.

In order to ensure safety, when they are activated, the tie rods (12) will lift a security plate (19) preventing the wheelchair from rolling back. Other simple devices, that are able to ensure the same type of safety, operating by gravity for example; can be installed both in the back as well as on the lateral edges of the platform (not represented). An audible and luminous alarm is activated during use of the platform. Said platform is equipped with sensors (15), in order to ensure that the activation of the platform (3) is only possible when the wheelchair is correctly positioned Likewise, the platform is equipped with a grab-bar (21) that is consolidated with the platform (3). At its end, said grab-bar incorporates a highly visible ringer button (25) and a luminous signal (26).

### DESCRIPTION OF EMBODIMENTS OF THE INVENTION

In order to better understand the description of the invention, we will describe the set of illustration plates and drawings of this document.

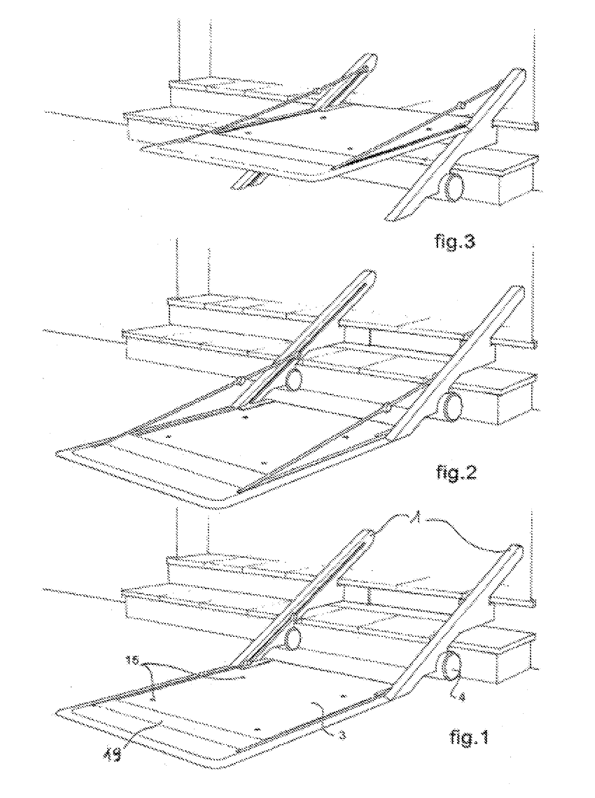

Illustration Plate 1 shows an overview of the invention and of the 3 operating positions, FIGS. 1, 2 and 3, (at rest, intermediate and raised), as well as a general view of its installation.

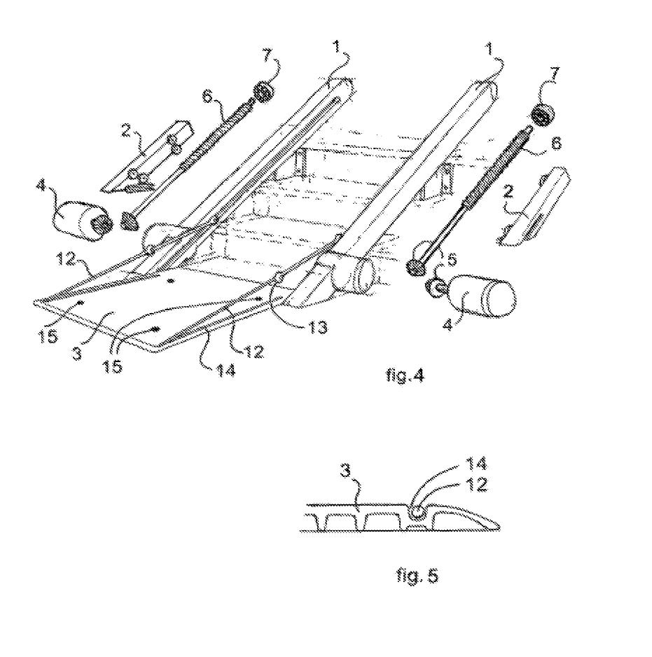

Illustration Plate 2 shows a general exploded view of all the parts that make up the invention in FIG. 4, and a detailed view of the platform highlighting the groove (14) housing the tie rod (12) at rest, FIG. 5.

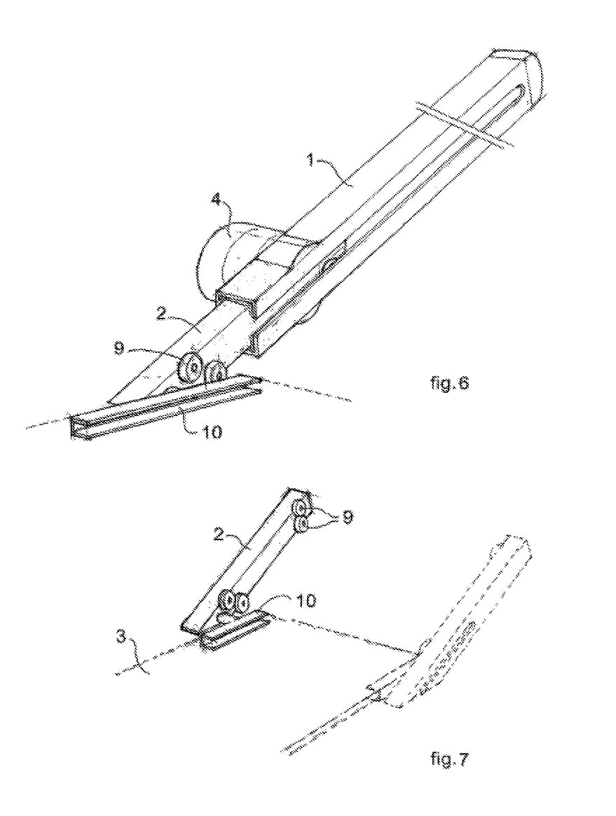

Illustration Plate 3 shows an important part of the invention, FIG. 6, represents the cross-member (1), in which is inserted the carriage (2), with its guide wheels (9), consolidated with the means of attachment of the platform. FIG. 7 shows a detailed view of the wheels (9) which allow the guiding.

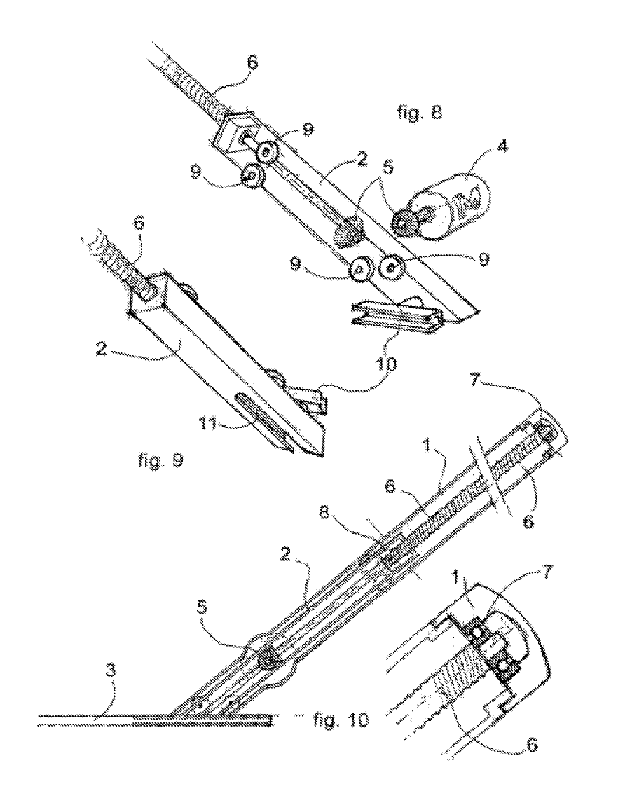

Illustration Plate 4 highlights various implementation details. FIG. 8 shows the various sub-assemblies that cooperate with one another to implement the operation of the invention. FIG. 9 shows the groove (11). FIG. 10 shows a longitudinal cross-sectional view of the whole: cross-member (1) carriage (2) endless screw (6) transmission by truncated pinions (5) driven by the motor (4).

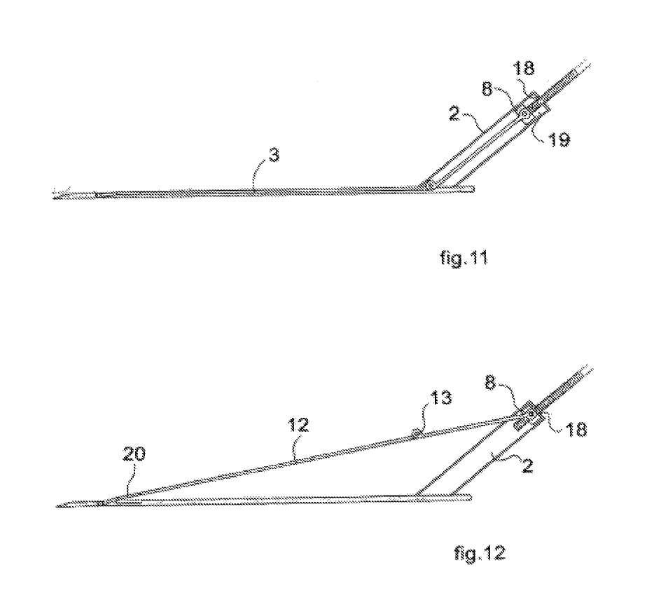

In FIGS. 11 and 12, illustration Plate 5 shows the ad hoc functional space (19) between the screw (8) and the carriage stop (18), in such a way that the tie rods are drawn tight up until the screw (8) returns into contact with the stop (18), then the action of the motor (4) will bring about the lifting of the platform (3). FIG. 12 shows the activation of the security plate (20) that is lifted under the lifting action of the 2 tie rods (12).

Illustration Plate 6 shows the implementation of the second means of movement of the platform (3) according to the version using a cable (16) that winds up on a pulley (17).

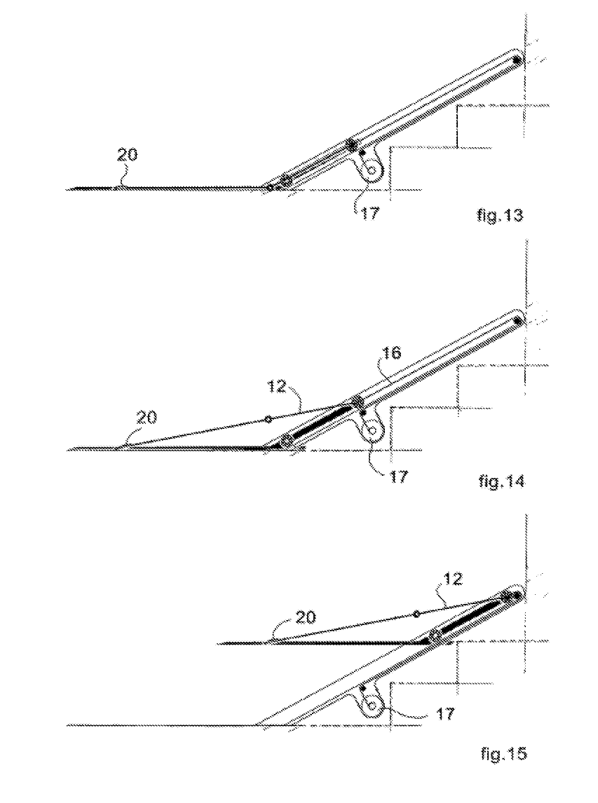

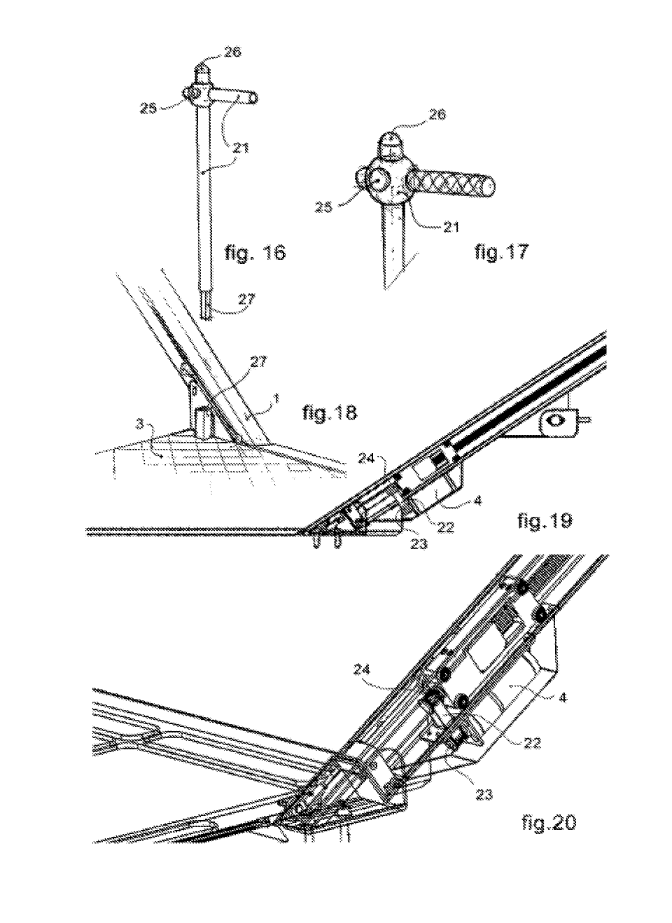

In FIGS. 16, 17 and 18, Illustration Plate 7 shows an installation of a grab-bar (21) that unites With the platform (3) by means of an interlocking male-female fixture (27), said grab-bar is provided with a ringer button (25) and an audible and luminous signal transmitter (26), which is triggered during the activation of the platform (3).

FIGS. 19 and 20 show another version of the mechanical transmission by a belt (22).

To gain access to the service offered by the invention, the interested users will have a remote control (not represented), specifically designed to activate the device, both for lifting and for lowering of the wheelchair by the platform, or to warn the person in charge of the location hosting the general public that a person would like to activate the innovation.

The invention described in this document is substantially intended for accessibility of persons in wheelchairs, however it can also be employed for other applications such as accessibility for baby carriages, for pregnant women or for elderly persons. For this purpose, the invention is provided with a grab-bar (21) that unites with the platform (3) by means of an interlocking male-female fixture (27), said grab-bar is provided with a ringer button (25), and an audible and luminous signal transmitter (26), which is triggered during the activation of the platform (3).

1. Platform lift for accessibility for people in a wheelchair, comprising a device for lifting of the platform comprising 2 cross-members acting as a guiding rail, secured to the staircase, including 2 carriages, to which a platform is secured, characterized by the fact that the lifting of the platform is carried out by 2 electric motors provided with a mechanical reducer and secured to the outside of the 2 cross-members, the shafts of the motors being provided with a drive device such as a truncated pinion on each end driving another truncated pinion united with an endless screw.

2. Platform lift for accessibility for persons in a wheelchair according to claim 1, wherein the endless screw is fitted on at least 2 bearings, and that the carriage is equipped with:
a screw secured to the carriage and cooperating with the endless screw in such a manner that the rotation of the endless screw drives the linear movement of the carriage secured to the carriage;
wheels in contact with the cross-member allowing an ad hoc guidance during the movement of the carriage on the inside of the cross-member;
a means of securing of the platform.

3. Platform lift for accessibility for persons in a wheelchair according to claim 2, wherein the lift device furthermore comprises 2 tie rods, articulated in such a way that, at rest, they recess in an adapted groove that is hollowed out into the length of the platform, said tie rods are secured on the one side on the screw and at the end of the platform on the other.

4. Platform lift for accessibility for persons in a wheelchair according to claim 3, wherein the tie rods will lift a security plate when they are activated.

5. Platform lift for accessibility for persons in a wheelchair according to claim 3 wherein, at the start, the screw is not in contact with the carriage stop, and where an ad hoc space is foreseen, allowing the screw to move into this space to tension the tie rod, before the screw touches down on the stop and drives the platform.

6. Platform lift for accessibility for persons in a wheelchair according to claim 1, wherein the motor is designed to rotate in one direction or the other respectively allowing the rise or the descent of the platform.

7. Platform lift for accessibility for persons in a wheelchair according to claim 1 wherein the 2 motors are synchronized in their rotation by appropriate electronics.

8. Platform lift for accessibility for persons in a wheelchair according to claim 1, wherein a grab-bar unites with the platform by means of an interlocking male-female fixture.

9. Platform lift for accessibility for persons in a wheelchair according to claim 1, wherein the device for the driving of the endless screw by the motor is a toothed belt, said belt is driven by a toothed pulley positioned at the end of the motor, driving another toothed pulley that is united with the endless screw.
